(19) United States
(12) Patent Application Publication
(10) Pub. No.: US 2009/0125335 A1
(43) Pub. Date: May 14, 2009

(54) Patient Treatment Planning System

(76) Inventors: Amy M. Manetta, North Billerica, MA (US); Jolyn Rutledge, Amesbury, MA (US); Christina L. Sizemore, Beverly, MA (US); Jaqueline Mulcahy, Natick, MA (US)

Correspondence Address: JACK SCHWARTZ & ASSOCIATES, 1350 BROADWAY, SUITE 1510, NEW YORK, NY, 10018, US

(21) Appl. No.: 12/264,627

(22) Filed: Nov. 4, 2008

Related U.S. Application Data
(60) Provisional application No. 60/985,307, filed on Nov. 5, 2007.

(51) Int. Cl. G06Q 50/00

(52) U.S. Cl. 705/3

(57) ABSTRACT

A patient treatment planning system includes at least one repository of medical information of a plurality of different patients. A data processor acquires patient data from the at least one repository for presentation in a user interface display and storing patient data acquired into the at least one repository. A user interface initiates generation of data representing a composite display image presenting patient data acquired from the at least one repository using the data processor, the composite display image enabling user initiation of execution of a plurality of different executable applications by the data processor including, a care planning application and a medication administration scheduling application. In response to user entry of data scheduling a care plan event for a particular patient, the care planning application automatically initiates medication conflict checking in response to scheduling the medication administration for the particular patient and the care planning application automatically conveying data identifying the care plan event and associated context data to the medication administration scheduling application for population of a medication administration schedule for display by the user interface.

### CROSS REFERENCE TO RELATED APPLICATIONS

This is a non-provisional application of provisional application Ser. No. 60/985,307 filed Nov. 5, 2007, by Amy Manetta et al.

### FIELD OF THE INVENTION

The invention relates to a patient treatment planning system for creating and editing of a patient treatment plan to be implemented by healthcare professionals.

### BACKGROUND OF THE INVENTION

In known systems, a physician creates a patient treatment plan and a nurse manually applies the plan to the patient. The nurse manually executes the plan and manually performs any conflict handling. A physician is typically not warned about duplications between his plan and the patient record and a nurse is burdened by the error prone process of having to take the physician plan and transcribe it. A system, according to invention principles, addresses these deficiencies and related problems.

### SUMMARY OF THE INVENTION

A patient treatment planning system and method includes at least one repository of medical information of a plurality of different patients. A data processor acquires patient data from the at least one repository for presentation in a user interface display and storing patient data acquired into the at least one repository. A user interface initiates generation of data representing a composite display image presenting patient data acquired from the at least one repository using the data processor, the composite display image enabling user initiation of execution of a plurality of different executable applications by the data processor including, a care planning application and a medication administration scheduling application. In response to user entry of data scheduling a care plan event for a particular patient, the care planning application automatically initiates medication conflict checking in response to scheduling the medication administration for the particular patient and the care planning application automatically conveying data identifying the care plan event and associated context data to the medication administration scheduling application for population of a medication administration schedule for display by the user interface.

### BRIEF DESCRIPTION OF THE DRAWINGS

FIG. 1 is a block diagram of a patient treatment planning system according to invention principles;

FIG. 2 is flowchart detailing a process performed by the patient treatment planning system according to invention principles; and

FIGS. 3-12 are exemplary screen shots at various stages of system operation according to invention principles.

### DETAILED DESCRIPTION

A processor as used herein is a device for executing stored machine-readable instructions for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller or microprocessor, for example. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

A system creates and applies a physician plan for patient related activities. The physician plan includes at least one event identifying an action to be performed on or on behalf of a patient. Exemplary events able to be selected or input by a user include any of medication administration, fluid administration, an assessment or an intervention. Medication administration and fluid administration events include data representing different medications and/or fluids to be provided to the particular patient as part of the physical plan for patient care. An assessment is any activity performed by a healthcare professional in evaluating a patient. An intervention is any activity or service that is performed for the particular patient. Associated with the at least one event is context data. Context data includes any data characterizing the event, including scheduling data detailing a time and/or frequency of occurrence for the event. The system advantageously and automatically warns a physician creating the physician plan if there are any duplicate events in the plan being created by comparing the plan being created with events in previous physician care plans and events in the patient record. When completed, the physician plan is automatically conveyed to another healthcare professional responsible for implementing the care plan, for example a nurse. Prior to implementation, the nurse acknowledges the plan and the plan and event and context data contained within the physician plan is automatically “transcribed” for use by individual applications. Transcription of the physician care plan includes conveying data to at least one of a further application associated with the respective event and able to schedule and implement the event in the plan. A consolidated view of the acknowledged physician care plan advantageously enables the physician to see the plans that have been created. The system further advantageously enables dynamic editing of patient care plan in response to conflicts between events by creating verbal entries including at least one of modifications of events in the physician plan or addition of further events to the plan. The system further advantageously reduces errors associated with manual transcription of patient plans by automatically transcribing and providing care plan event orders to respective applications for scheduling and/or implementing patient care events. Verbally entered events are further appended with authorization identifiers enabling a user to identify who ordered the modification or additional event. The consolidated view of the acknowledged physician care plan provides a complete view of the patient record and advantageously automatically warns about duplications and inconsistencies providing an important safety checking mechanism.

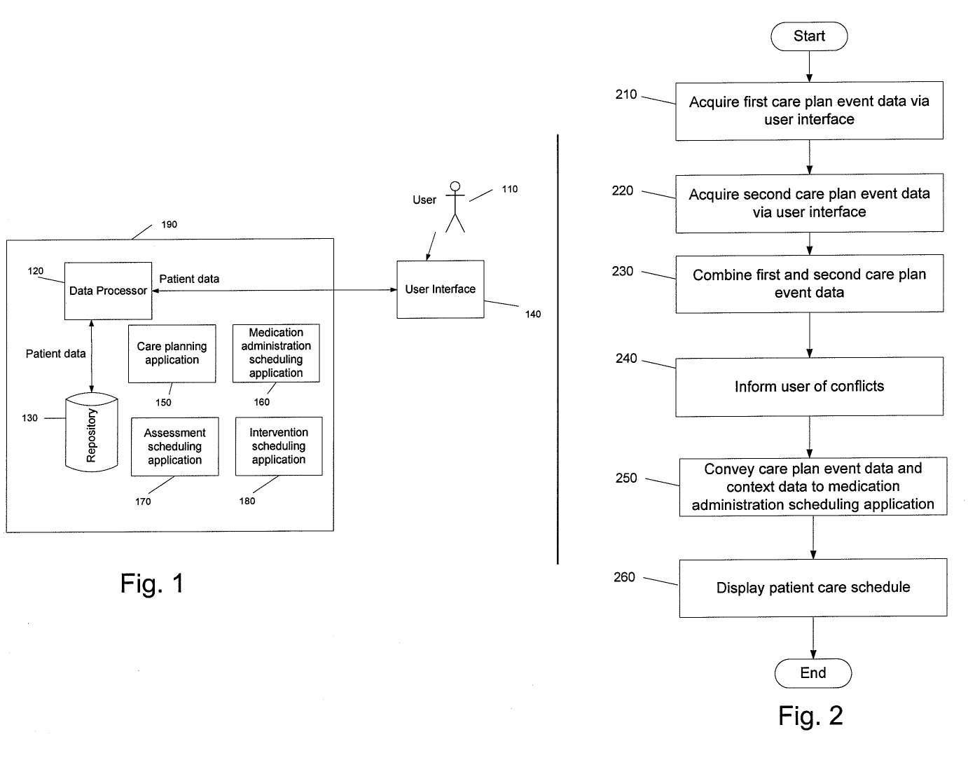

FIG. 1 illustrates an embodiment the patient treatment planning system 100. System 100 includes a server 190 and a user interface 140 electrically coupled to server 190. The server 190 includes a data processor 120, a repository 130, a care planning application 150, a medication administration scheduling application 160, an assessment scheduling application 170, and an intervention scheduling application 180. One skilled in the art will recognize that other embodiments of the invention are easily constructed. For example, in one embodiment the functions of the server and user interface may be consolidated into a single processing device (PC, notebook, phone, PDA, etc.) and that in another embodiment they may be distributed across a network. Additionally, one skilled in the art will recognize that, though described as applications, care planning application 150, medication administration scheduling application 160, assessment scheduling application 170, and intervention scheduling application 180 are not limited to software embodiments and instead are formed as hardware components (e.g. processors) comprised of electronic circuits having instructions hard coded therein to operate in the manner described below.

User 110 using user interface 140 is able to input, select or direct acquisition of patient data representing medical information for the patient from a repository 130 using data processor 120. The medical information is used in creating a patient care plan for treating the patient. User interface 140 provides display images enabling selection of at least one executable application used in creating the patient care plan. Creation of the patient care plan is enabled in response to initiation of patient care planning application 150. Patient care planning application 150 enables user 110 to select at least one patient care event for use in treating a patient for a particular problem. As used herein a problem includes any medical condition, diagnosed or undiagnosed, that is affecting the patient. Additionally, patient care planning application 150 enables a user to input or select context data to be associated with the event data. The patient care plan created via care planning application 150 includes a plurality of different types of events to be performed with respect to the particular patient. Upon selection of a respective event, patient care planning application 150 automatically performs an event conflict checking process and searches repository 130 for patient records and/or previous patient care plans associated with the particular patient to determine if the event being added already exists and is therefore a duplicate event. This automatic conflict checking process is performed for each event added by a physician to the patient care plan using the care planning application 150. The process of conflict checking is performed by the data processor and in response to initiation of an executable application by comparing event data values and/or context data values of the proposed event to event and/or context data values of any existing events for the particular patient. If a duplicate event is detected, system 100 notifies the user of a potential conflict. The conflict resolution process performed by system 100 is event specific. For example, if the duplicate event detected by system 100 involves a medication administration event, a user is notified that an existing event is already associated with the patient. Duplicate event notification occurs any time that proposed event data values match the existing event data values exclusive of context data associated with either the proposed or existing event (e.g. event data for administration of morphine is identified as duplicate despite dosing amounts not being equivalent). System 100 further provides a second level of conflict checking whereby, upon proposed event data being equal to existing event data, comparing context data of the proposed event with context data of the existing event. The user can selectively determine whether or not the duplicate medication administration should be added to the patient care plan based on the comparisons made by system 100. Alternatively, system 100 enables a user to selectively update or modify existing event data with the context data for that event in the physician care plan being created by the physician. However, care planning application will not permit addition of a duplicate assessment or intervention and instead, a user is presented with the option of replacing the existing event or modifying the context data of the existing event in accordance with the context data associated with the proposed event in the physician care plan.

User interface 140 further initiates generation of a display image enabling a user to create a physician care plan templates for use in generating a patient care plan using the care planning application 150. Physician care plan templates are selectively titled and are used for treating a particular medical condition or problem. The templates are created in response to user adding data representing at least one event and associated context data to the template. During template creation, care planning application 150 automatically performs a conflict check by comparing event data and context data sought to be added to the template with all other event and context data that was previously added to the care plan template. If the event is a medication administration event, care planning application 150 automatically notifies the user that equivalent event data exists in the care plan template and enables the user to add the duplicate event data to the care plan. If the event is either an assessment event or intervention event, care planning application 150 notifies the user of the duplicate assessment or intervention sought to be added and enables the user to replace the existing assessment or intervention with the proposed assessment or intervention. System 100 further enables a user to update and/or modify context data associated with the existing assessment or intervention with the context data associated with the proposed assessment or intervention event. For example, if a patient care plan includes an existing intervention event for ambulating the patient including context data defining a scheduled time for performing the intervention, system 100 enables a user to selectively modify the context data defining a scheduled performance time with updated context data derived from the proposed event and associated context data. Alternatively, system 100 may automatically prevent a user 110 from selecting a particular event by removing (or rendering inactive) any image elements used in selecting the event.

An exemplary structure of a physician care plan created by user 110 is described below. The physician plan template created in the manner discussed above includes a set of problems and a set of events for use by the physician for use in treating the patient's medical condition. Events include any of medication administration, fluid administration, assessments and interventions. The events include associated context data defining name, type, patient association and schedule data for the event. The physician car plan is created by adding care plan templates and/or by adding/removing individual events to patient care plan.

Physician care plan is derived by user selection and/or input of data values in fields of a care plan database. A first table includes a listing of medical conditions (problems) to be treated. The Physician Problem table includes a code and a string for identifying and linking the problem to be treated with either the template or the patient care plan. An exemplary structure of the Physician Problem table is:

t_physicanProblems

Problem code

Problem String

A Physician Plan table is a table used in creating the physician plan for the patient. Physician Plan table maintains the information needed to display a display image representing a template care plan or the physician care plan on user interface 140 at a particular time and on a particular screen defined by the value in the care unit field and creation time field. An exemplary structure of the Physician Plan table is:

| | |
|---|---|
| t_physicianPlan | |
| * Poid | // Setup Poid for templates |
| * Plan Id | // Identity |
| * Plan Name | |
| * Creation time | // Time the plan was created |
| * create User | // user id of who created the plan |
| * acknowledge Stated TS | // Nurse stated plan start time |
| * acknowledge TS | // time the plan was acknowledged |
| * acknowledge User | // user id of who acknowledged the plan |
| * state | // implemented, completed or acknowledged. |
| * care Unit | |

Data from the Physician Problem table and Physician Plan table are used to populate a Physician Plan Problems table indicating the problems selected for treatment by the physician plan and structured, for example, as:

t_physicianPlanProblems

plan Id

problem Code

problem string

A Physician Plan Entry table includes data representing event and associated context data for use in treating a medical condition of a patient and for directing other computer systems and/or applications in performing the listed events. Data in Physician Plan table is automatically conveyed to a computer system in a care unit indicated in Physician Plan table. The Physician Plan Entry table includes all events and associated context data and, in order to become active, must be acknowledged by a healthcare professional responsible for implementing the plan. The acknowledgement process and effect thereof will be discussed below. An exemplary Physician Plan Entry table is structure as:

| | |
|---|---|
| t_physicianPlanEntries | |
| * plan Id | |
| * entry type | // Fluid, Meds, Assessment, or Intervention |
| * entry Id | // parameter Instance of Fluid, Meds, Id of |
| | Assessment, Intervention |
| * entry Name | |
| * Schedule Id | // Used for everything except fluids. |
| * Schedule Name | |
| * entryVerified | |

Physician Plan Detail Header and Detail Row tables include data representing medication administration or fluid administration event generated in response to user input via an input dialogue box generated by the medication administration scheduling system. When a plan is acknowledged and implemented for application to the patient, the data is in Physician Plan Detail Header and Detail Row tables are copied to the original IO Detail Header and Row tables. Exemplary structures for Physician Plan Detail Headers and Detail Rows are:

| | |
|---|---|
| t_physPlanDetailHeader | |
| * paramInstance | |
| * poid | |
| * paramIdx | |
| * type | |
| * label | |
| * color | |
| * med amount | |
| * med amount exp | |
| * fluid volume | |
| * dose exp | |
| * use weight | |
| * minutes | |
| * caloric data | |
| * max volumne | |
| * complex schedule id | |
| t_physPlanDetailRow | |
| * cid | |
| * paramInstance | |
| * compIndex | |
| * label | |
| * uom | |
| * type | -- 1 = rate, 2 = volume, 0 = other |
| * order | |
| * carry | |
| * display | |
| * volumeLimit | |
| * DRdoubleESig | |
| * scheduledData | -- the default “data” for t_ioDetail if this |
| | is scheduled |
| * scheduledValue | -- the default “value” for t_ioDetail if |
| | this is scheduled |

Once created, data representing the physician care plan is automatically conveyed, by data processor 120, to a plurality of different scheduling applications responsible for scheduling and implementing the events in the physician care plan. User 110 responsible for implementing physician care plan selects a display image element initiating an executable application acknowledging that the physician care plan is ready for implementation. In response to execution of the acknowledgement application, event and associated context data in the physician care plan is automatically provided to individual event scheduling applications 160, 170 and 180 and physician care plan is transcribed to these scheduling applications. Transcription of physician care plan events will now be discussed with respect to the individual scheduling application tasked with implementing performance of the particular event. While each scheduling application is discussed individually, one skilled in the art will appreciate that transcription of event data to the scheduling applications occurs automatically in response to initiating the acknowledgement application and the processes performed by the respective scheduling applications occur substantially simultaneously to advantageously create a patient treatment plan from the physician care plan while providing multiple conflict checking operations ensuring patient safety.

Event data in the physician care plan indicating one of a fluid administration or medication administration is automatically provided by data processor 120 to the medication administration application 160. Medication administration application selectively controls the implementation schedule for any fluid or medications needed to be administered in accordance with the physician care plan. Operation will be described with reference to a medication administration event, but medication administration application 160 operates in a similar manner when the event data identifies a fluid administration needed to be performed. Medication administration application 160 receives a proposed medication administration event data and associated context data including schedule data derived from the physician care plan and automatically employs a medication event conflict checking process. The medication event conflict checking process includes searching the patient record and/or previously non-acknowledged care plans for the particular patient and comparing proposed event data values and/or context data derived from physician care plan with existing event data and/or context data values. If the values conflict indicating a duplicate event, a user is provided with an option to (a) add the duplicate event, (b) modify the existing event with context data associated with the event in the physician care plan or (c) take no action resulting in maintaining the existing event data and not implementing the event derived from the physician care plan. In the event that a conflict check results in no duplicate events or if a user determines it appropriate to order the duplicate event, medication event data and associated context data is communicated to medical administration scheduling application 160. Event and context data communicated includes, for example,

### Fluids

Patient identifier

Fluid definition which can include
Label
Rate
Volume
Volume limit
Supplemental data such as additives, bag amount etc.
Color
Uom (unit of measure)

Default values

### Medications

Patient identifier

Schedule identifier

Medication definition including
Label
Dose
Rate
Volume
Supplemental data
Color
Uom

Default values

Event data in the physician care plan indicating an assessment event is automatically provided by data processor 120 to the assessment scheduling application 170. Assessment scheduling application 170 selectively controls the implementation schedule for performance of an assessment used in evaluating a patient condition in accordance with the physician care plan. Assessment scheduling application 170 receives a proposed assessment event data and associated context data including schedule data derived from the physician care plan and automatically employs an assessment conflict checking process. The assessment conflict checking process includes searching the patient record and/or previously non-acknowledged care plans for the particular patient and comparing proposed assessment event data values and/or context data values derived from physician care plan with existing assessment event data and/or context data values. If the values conflict indicating a duplicate assessment event, a user is provided with an option to (a) modify the existing event with context data associated with the event in the physician care plan or (b) take no action resulting in maintaining the existing event data and not implementing the event derived from the physician care plan. Modifying the existing event with context data from physician care plan is a scheduling override action enabling maintenance of the assessment but changing the time and/or frequency at which the assessment is performed. Alternatively, if the assessment conflict checking process results in a duplicate assessment event in the patient record without schedule data associated therewith, the existing assessment event is automatically updated with scheduling data derived from the matching assessment event in the physician care plan. In the event that a conflict check results in no duplicate events or if a user determines it appropriate modify the existing event, assessment event data and associated context data is communicated to assessment scheduling application 170. Assessment event and context data communicated includes, for example,

| | |
|---|---|
| patient identifier | |
| Assessment identifier | |
| Schedule identifier | For serial assessments |
| Start time | For serial assessments |

Event data in the physician care plan indicating an assessment event is automatically provided by data processor 120 to the intervention scheduling application 180. Intervention scheduling application 170 selectively controls the implementation schedule for performance of an intervention in accordance with the physician care plan. Assessment scheduling application 180 receives proposed intervention event data and associated context data including schedule data derived from the physician care plan and automatically employs an intervention conflict checking process. The intervention conflict checking process includes searching the patient record and/or previously non-acknowledged care plans for the particular patient and comparing proposed intervention event data values and/or context data values derived from physician care plan with existing intervention event data and/or context data values. If the values conflict indicating a duplicate intervention event, a user is provided with an option to (a) modify the existing event with context data associated with the event in the physician care plan or (b) take no action resulting in maintaining the existing event data and not implementing the event derived from the physician care plan. Modifying the existing event with context data from physician care plan is a scheduling override action enabling maintenance of the intervention but changing the time and/or frequency at which the intervention is performed. Alternatively, if the assessment conflict checking process results in a duplicate intervention event in the patient record without schedule data associated therewith, the existing intervention event is automatically updated with scheduling data derived from the matching intervention event in the physician care plan. In the event that a conflict check results in no duplicate events or if a user determines it appropriate modify the existing event, intervention event data and associated context data is communicated to intervention scheduling application 170. Assessment event and context data communicated includes, for example,

patient identifier

Intervention identifier

Schedule identifier

Start time

Intervention group

Additionally, user interface 140 provides a display image enabling a user to add ancillary event and context data to the physician care plan that was not previously included in the physician care plan. Ancillary event and context data is added for example, in response verbal order issued by a healthcare professional. Ancillary event and context data is available to be added using any of the scheduling applications 160, 170 and 180. Ancillary event and associated context data is added via a respective one of the scheduling applications 160, 170, 180 and data representing the ancillary event and context data is automatically conveyed to care planning application 150 for display in an associated display image indicating all events in the physician care plan. For example, ancillary event and context data includes:

### Verbal Entry

Patient identifier

Entry name

Schedule name

Entry time

Entry text which describes entry

An exemplary structure for ancillary event data table for indicating that an ancillary event was assigned during the acknowledgement process is:

t_physPlanAppliedEntries

| | |
|---|---|
| * textEntryId | // for uniqueness |
| * poid | |
| * plan Name | // Plan this entry originated from or Verbal Order |
| * plan Id | |
| * entry Name | |
| * schedule name | |
| * careUnit | |
| * entryTS | // Timestamp of the entry - Used for ordering |
| | and CU stay |
| * entryText | // Text of entry |
| * order type | // Plan, Verbal or incomplete |
| * reviewedByMD | // Flag indicating this entry was reviewed by |
| | MD |

Another embodiment of system 100 includes at least one repository 130 of medical information of a plurality of different patients. A data processor 120 is electrically coupled to the at least one repository 130 and acquires patient data from the at least one repository 130 for presentation in a user interface display and stores patient data acquired into the at least one repository 130. A user interface 140 initiates generation of data representing a composite display image presenting patient data acquired from the at least one repository 130 using the data processor 120, the composite display image enabling user initiation of execution of a plurality of different executable applications including, a care planning application 150 and a medication administration scheduling application 160. In response to user entry of data scheduling a care plan event for a particular patient, care planning application automatically initiates care plan event conflict checking in response to scheduling said care plan event for said particular patient and automatically conveys data identifying the care plan event and associated context data to the medication administration schedule 150 for population of a displayed medication administration schedule.

The user interface 140 automatically conveys data identifying the care plan event and associated context data to the medication administration schedule without user manual data entry and the context data comprises a patient identifier and care plan event identifier. The context data comprises a user identifier and care plan event scheduled time and date and a care plan event description element. The composite display image enables user initiation of execution of a plurality of different executable applications including, an interventions scheduling application 180 and an assessment scheduling application 170 and in response to user entry of the care plan event for the particular patient, the user interface automatically conveys data identifying the care plan event and associated context data to the interventions scheduling application 180 and the assessment scheduling application 170. Additionally, care planning application 150 further automatically initiates conflict event checking process in response to initiating scheduling of an assessment and/or intervention. A display image enabling scheduling of an intervention event comprising an activity involving a healthcare worker performing a service for the particular patient is presented in response to user initiation of execution of the interventions scheduling application 180 and in response to user entry of an intervention event for the particular patient, the user interface 140 automatically conveys data identifying the intervention event and associated context data to the care planning application 150 for population of a care plan schedule of the particular patient. The care planning application 150 automatically initiates intervention conflict checking in response to scheduling of the intervention for the particular patient and the intervention scheduling application 170 automatically initiates a second conflict checking in addition to the intervention conflict checking performed by the care planning application 150. Intervention conflict checking comprises at least one of, (a) duplicate intervention checking and (b) intervention schedule checking.

A display image enabling scheduling of an assessment event comprising an activity involving a healthcare worker performing an assessment of an aspect of a medical condition of the particular patient is presented in response to user initiation of execution of the assessment scheduling application 170 and in response to user entry of an assessment event for the particular patient, the user interface automatically conveys data identifying the assessment event and associated context data to the care planning application 150 for population of a care plan schedule of the particular patient. The care planning application automatically initiates assessment conflict checking in response to scheduling of the assessment for said particular patient and the assessment scheduling application 170 automatically initiates a second conflict checking in addition to the assessment conflict checking performed by the care planning application 150. Assessment conflict checking comprises at least one of, (a) duplicate assessment checking and (b) assessment schedule checking.

A display image enabling scheduling of a medication administration event comprising an activity involving a healthcare worker administering a medication to the particular patient is presented in response to user initiation of execution of the medication administration scheduling application 160 and in response to user entry of a medication administration event for the particular patient, the user interface automatically conveys data identifying the medication administration event and associated context data to the care planning application for population of a care plan schedule of the particular patient. The medication administration scheduling application includes a patient fluid scheduling application. The patient fluid scheduling application enables scheduling of at least one of, (i) intra-venous medications and (ii) patient fluid output handling.

A care plan display image is presented for scheduling care plan events in response to user initiation of execution of the care planning application 150 and the care plan display image enables a user to schedule a care plan event for the particular patient comprising a medication, intervention or assessment. A care plan display image is presented for scheduling care plan events in response to user initiation of execution of the care planning application 150 and the care plan display image enables a user to schedule a care plan event comprising medication administration for the particular patient and the care planning application automatically initiates medication safety (conflict) checking in response to scheduling the medication administration for the particular patient using the care plan display image. The medication safety checking comprises at least one of, (a) duplicate medication checking, (b) medication interaction checking and (c) dosage checking. The medication administration scheduling application 150 initiates performance of a second medication safety check in addition to the medication safety checking initiated by the care planning application.

A conflict resolution display image is presented for resolving conflicts identified by the care plan conflict checking process. The conflict resolution display image notifies a user of conflicts between care plan events and enables a user to schedule a care plan event including associated context data identified as conflicting with another different care plan event. Data identifying the duplicate care plan event and associated context data is automatically conveyed to the medication administration scheduling application for population of a medication administration schedule for display by the user interface. Conflicting and/or duplicate events are identified irrespective of the context data associated with events. For example, should two event identifiers identifying the same medication but each event includes a different dosage to be applied, the event is identified in the conflict display image and a user is able to selectively determine if the duplicate care plan event is to be added to the care plan.

FIG. 2 illustrates a process performed by one embodiment of the patient treatment planning system 100. In blocks 210 and 220, the data processor 120 acquires first and second care plan event data entered by the user 110 via the user interface 140. In blocks 230 and 240, the care planning application 150 combines the care plan event data and checks for conflicts by comparing event data values and associated context data values with existing event data values stored in one of a patient record and a previous physician care plan. In block 240, the user interface 140 displays data informing the user of conflicts. Displaying data as in block 240 further includes displaying user selectable image elements enabling a user to add a duplicate event to the physician plan or modify context data associated with the existing event with the context data listed in the physician care plan for the respective event. In block 250, the care planning application 150 conveys the combined care plan event data and associated context data to the medication administration scheduling application 160. In block 260, the user interface 140 displays data representing a patient care schedule. FIG. 2 is an exemplary description of the operation of the care planning application 150 and the medication administration scheduling application 160. However, one skilled in the art will readily appreciate that similar processes including operation of the care planning application 150 with each of the assessment scheduling application 170 and intervention scheduling application 180 is possible. As discussed above, conflict checking for the individual events listed in physician care plan is automatically performed by system 100. System operation differs with respect to the type of event data being checked for conflicts. In the event the event data is a medication or fluid administration event, system 100 enables user 110 to add a duplicate event or modify the existing event and/or context data associated therewith. In the event that the event data is either an assessment or intervention, system 100 prevents user 110 from adding the event to the physician care plan but provides a selectable image element enabling modification of the existing event with context data derived from physician care plan or enabling replacement of the event in the patient record with the event in the physician care plan.

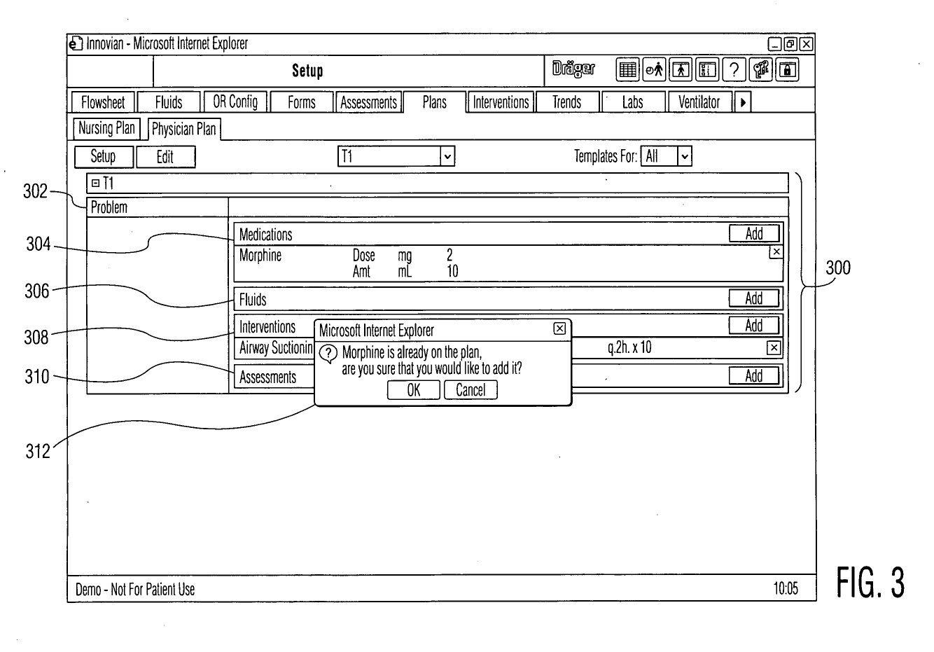

FIGS. 3-12 are exemplary screen shots including display images generated by user interface 140 for display at various stages of system operation. System enables a physician to create templates which are comprised of one or more physician problems and a set of medications, fluids, interventions and assessments. Each template can contain any number of medications, fluids, interventions and assessments, each of which can be assigned a schedule for administration to a patient for treating the medical condition of the patient. On the patient physician plan screen system 100 enables user creation of a physician care plan by adding one or more templates or by adding and removing the entries (problems, medications, fluids, interventions and assessments) manually. Schedules can be changed or removed via a pop-up box displayed when the user selects an event entry (medication, fluid, intervention or assessment). When a plan is being built by the physician, care planning application 150 automatically checks the existing plan for equivalent events to determine if duplications are present and enables a user to selectively determine how to handle duplications based on the type of event determined to be a duplicate event.

Physician plan creation screen is shown in FIG. 3 and includes a care plan template 300 including data representing a medical problem 302 and a plurality of different types of events and associated context data for use in treating medical problem 302. The events include a medication administration event 304, a fluid administration event 306, an intervention event 308 and an assessment event 310. If a user attempts to add a duplicate fluid or medication to the template (even with a different dose or rate as indicated by the associated context data) user interface initiates generation of a notification dialogue box 312 alerting the user that the event already exists in the physician care plan. Notification box 312 includes a selectable image element enabling a user to either add the duplicate event or take no action with respect to the event. The exemplary event in FIG. 3, illustrates system response when the duplicate event is a medication administration event. Display images generated in response to other event conflicts will be discussed below. System response

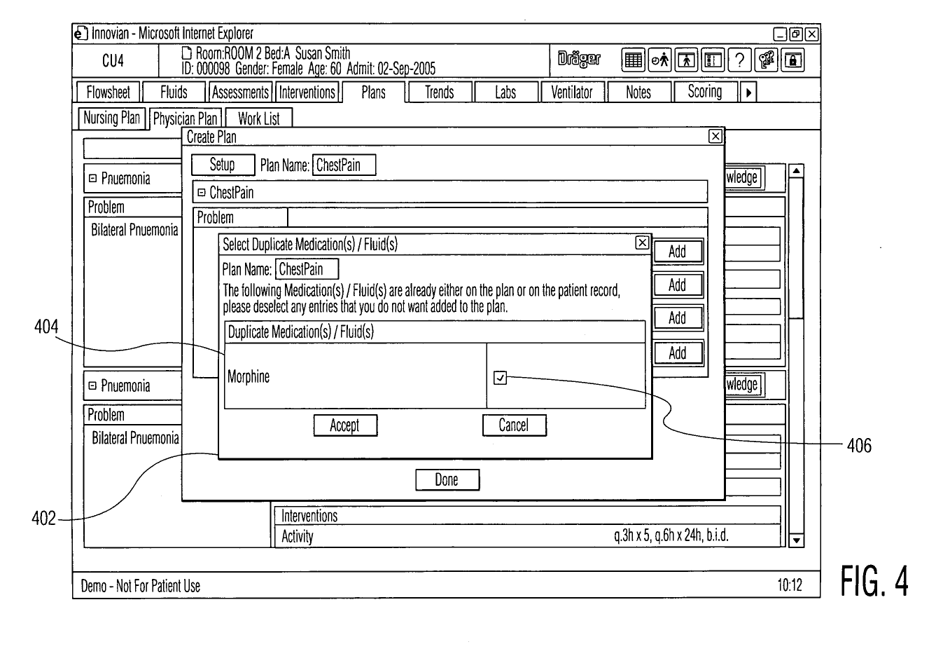

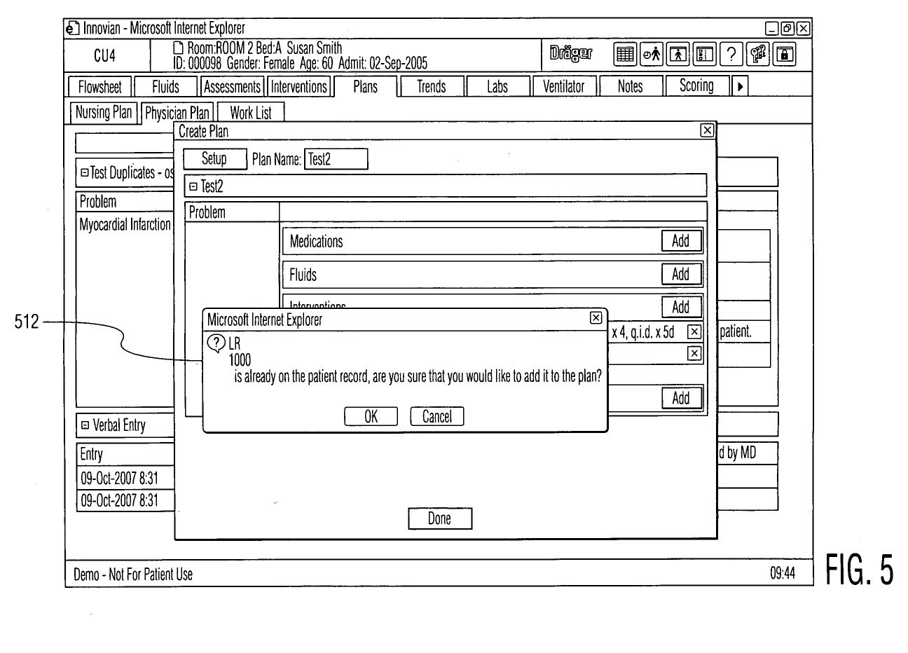

FIGS. 4 and 5 are exemplary display images generated by system 100 in response to user selection of a medication event determined to be in conflict with an existing medication event. The display image 400 of FIG. 4, is presented in response to user selection of the image element in Notification Box 312 in FIG. 3, indicating that the duplicate event should be added. User interface 140 generates dialogue box 402 including event data 404 identifying the event to be added with a selection box 406 indicating that the user wishes to add the duplicate event 404. Marking selection box 406 and selecting to proceed, automatically adds the event data 404 to the physician care plan. As shown herein, a duplicate morphine administration is added to the physician care plan for the particular patient. FIG. 5 is a further exemplary display image including a notification box 512 notifying the user that the desired medication event sought to be added to the physician care plan is already present in either the patient record or a previously non-acknowledged patient care plan.

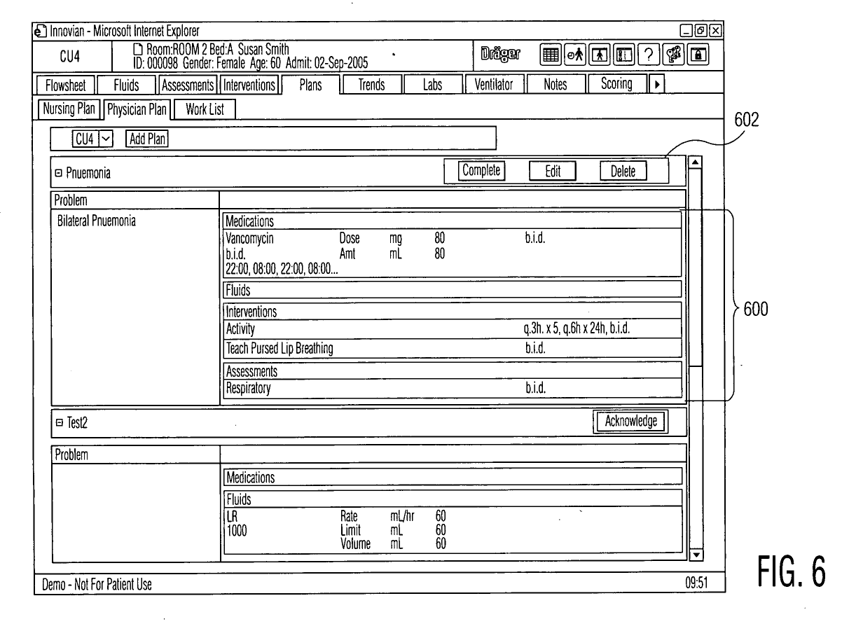

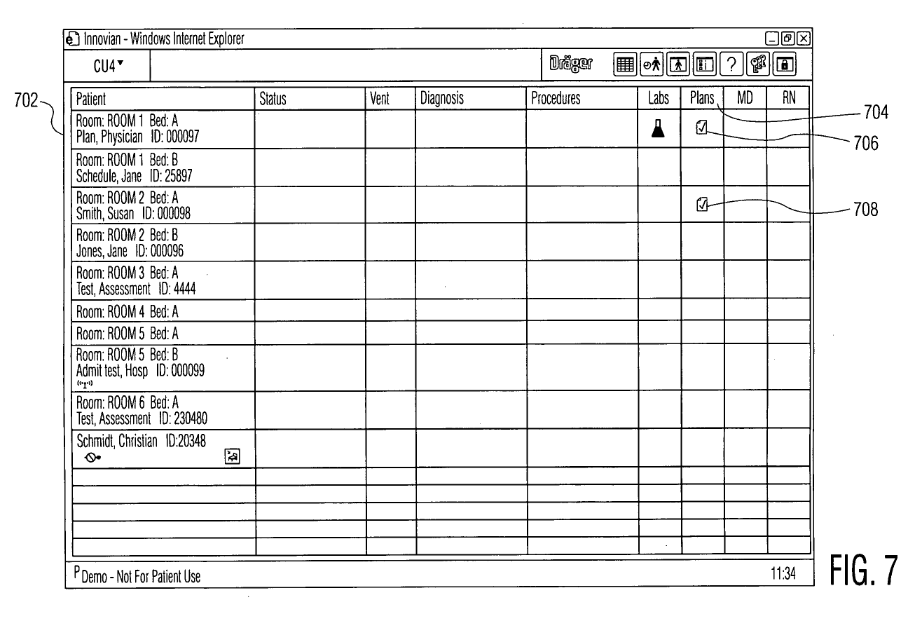

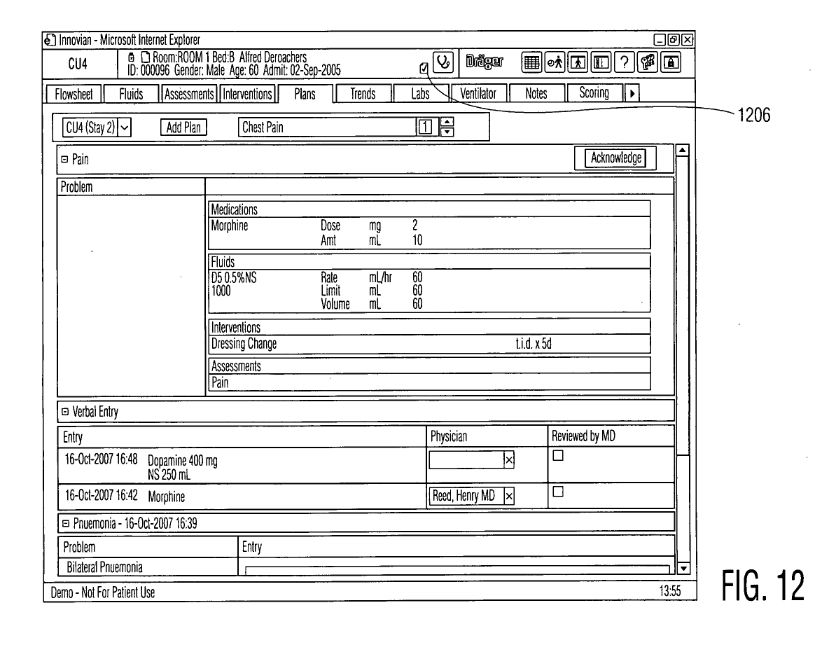

FIG. 6 is a composite display image generated by user interface 140 displaying a physician care plan created by a user 110. A user selectable image element 602 initiates completion of the physician care plan. In response to selection of image element 602, data representing the physician care plan including events that comprise the plan and any associated context data is automatically conveyed by data processor 102 to location in a healthcare enterprise where the patient is currently located. Once completed and communicated to the target care unit, a healthcare professional responsible for implementing the physician care plan is notified, for example via an electronic white board display shown in FIG. 7. A visual indicator 706 and 708 are generated and displayed in a column indicating that physician care plans for those patients are completed and are waiting to be acknowledged by a nurse for implementation thereof. A similar indicator is selectively displayed in FIG. 12 and further alerts the nurse that a complete physician care plan exists for the respective patient.

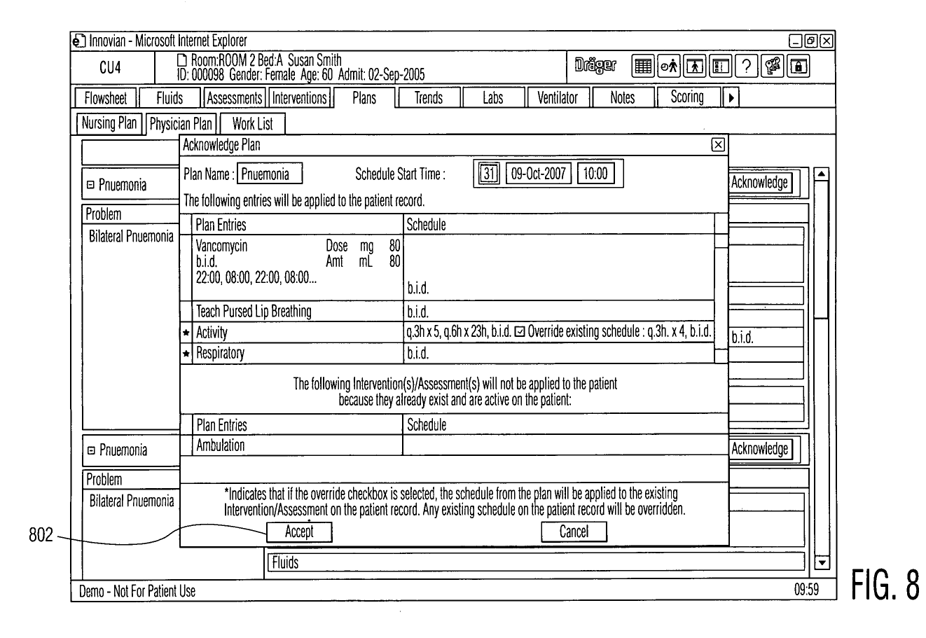

Upon notification via indicator 706 or 708, a nurse selects the completed plan and is able to acknowledge the plan by selecting image element 802 shown in FIG. 8 When acknowledging a plan includes at least one intervention or assessment, the following event conflict checking process is performed by the invention scheduling application and assessment scheduling application, respectively. The checking process occurs for the respective event entry and includes the following steps:

1. If there is no entry for the listed event on the patient, the entry on the plan is applied to the patient with the schedule (if any) from the physician plan.

2. If there is an entry on the patient (with or without a schedule) and the entry on the physician plan has no schedule, nothing is done.

3. If the entry on the physician plan has a schedule and the entry on the patient has no schedule, the entry on the patient is modified to include the schedule from the physician plan.

4. If the entry on the plan has a schedule and the entry on the patient has a schedule, the nurse is given the choice to keep the current schedule on the patient or to override it and modify the schedule to match the schedule from the plan.

Additionally, medication administration scheduling application automatically performs a second conflict check in a manner described above with respect to FIG. 3-5.

When the nurse acknowledges the plan, each entry on the plan is “transcribed” with the planned schedule to the appropriate application screen on the patient record.

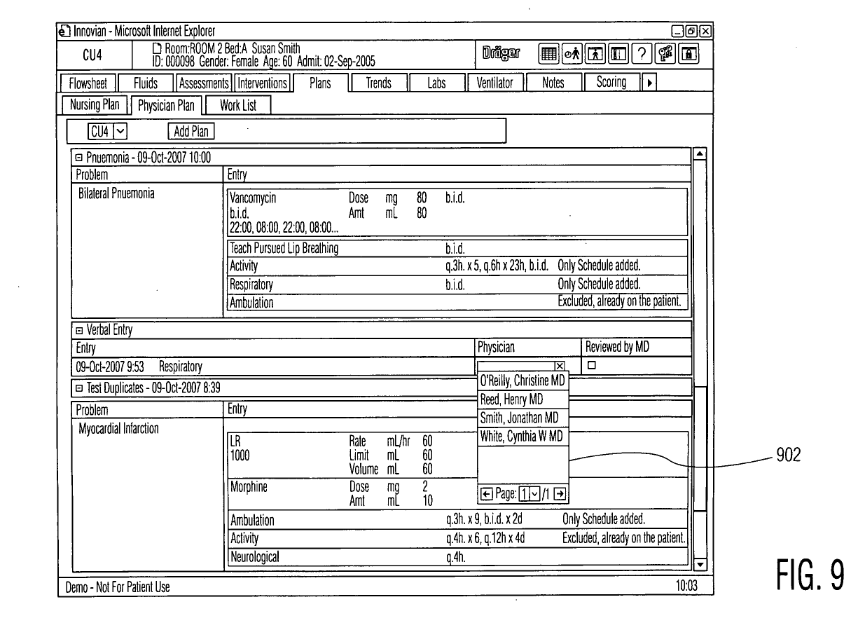

FIG. 9 is a composite display image generated by user interface 140 enabling a user to add at least one of ancillary event and associated context data in response to the results of a conflict checking process for a particular event in physician care plan. The ancillary event and context data represents an event or data about an event that was not on the physician care plan. Thus, system enables a user to selectively identify a healthcare professional that approved the addition or modification of the event in the care plan. A “Reviewed by MD” checkbox is also provided to allow the physician to indicate that he reviewed the verbal entry. For example, drop down window 902 includes a plurality of healthcare professionals able to be selected by nurse to indicate that the modification to the plan is authorized. These verbal entries advantageously enable the nurses who are implementing the plans to modify the physician care plan in response to determination that conflicting and/or duplicate events are present in the care plan and in the patient record. Alternatively, verbal entries are entries that are manually added by a user to the physician plan screen using respective scheduling applications. The patient plan screen in FIG. 9 is a consolidated view showing plans being edited by doctors, plans waiting to be acknowledged by a nurse, plans already acknowledged and “transcribed” to the patient record as well as verbal entries of ancillary event data associated with the particular patient. The consolidated view is an ordered view. Plans which are being edited by the physician or waiting for a nurse to acknowledge are displayed newest to oldest on top, while all other plans and verbal entries are displayed next, newest to oldest. A consolidated view of plans for the patient in another care unit can be seen by selecting that appropriate care unit in the care unit selection pulldown menu.

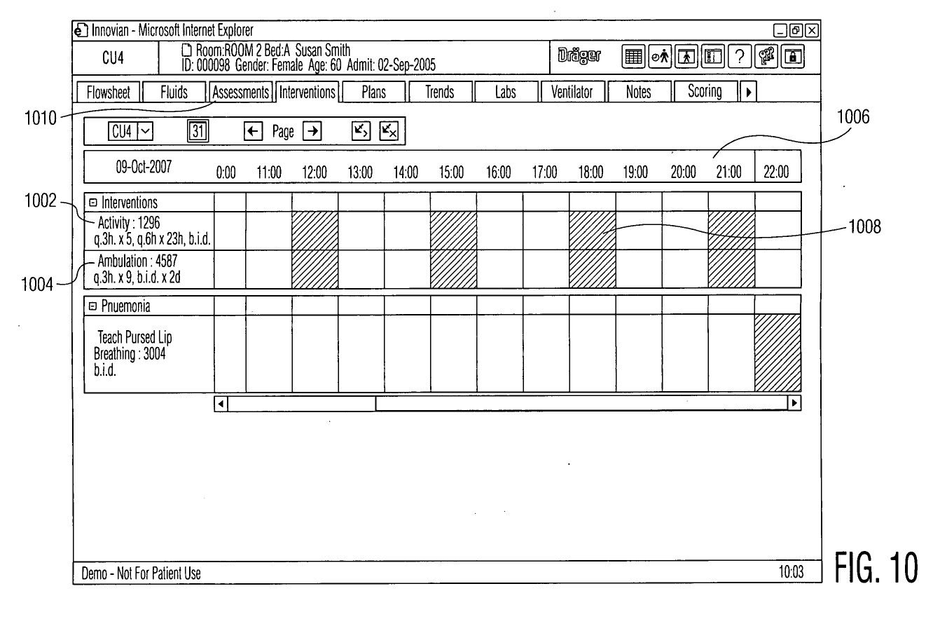

Once acknowledged, data representing the events listed in physician care plan along with the associated context information are automatically conveyed to the respective event scheduling application for display in a schedule. The acknowledged care plans are automatically transcribed and provided to respective scheduling applications for population of event schedules with event data from the physician care plans. An exemplary display image of the intervention scheduling application 180 is shown in FIG. 10. The events are listed in rows 1002 and 1004 including event identifiers and associated scheduling data. A time bar 1006 is displayed showing a range of time and includes indicators 108 indicating when, for example, a respective event is to be performed for the patient. While FIG. 10 shows an exemplary display image of the intervention scheduling application 180, similar display images are displayed in response to user selection of a corresponding scheduling application tab. For example, tab 1010 corresponds to the assessment scheduling application 170. Any assessment events in the physician care plan and their associated schedules would be displayed upon selection thereof.

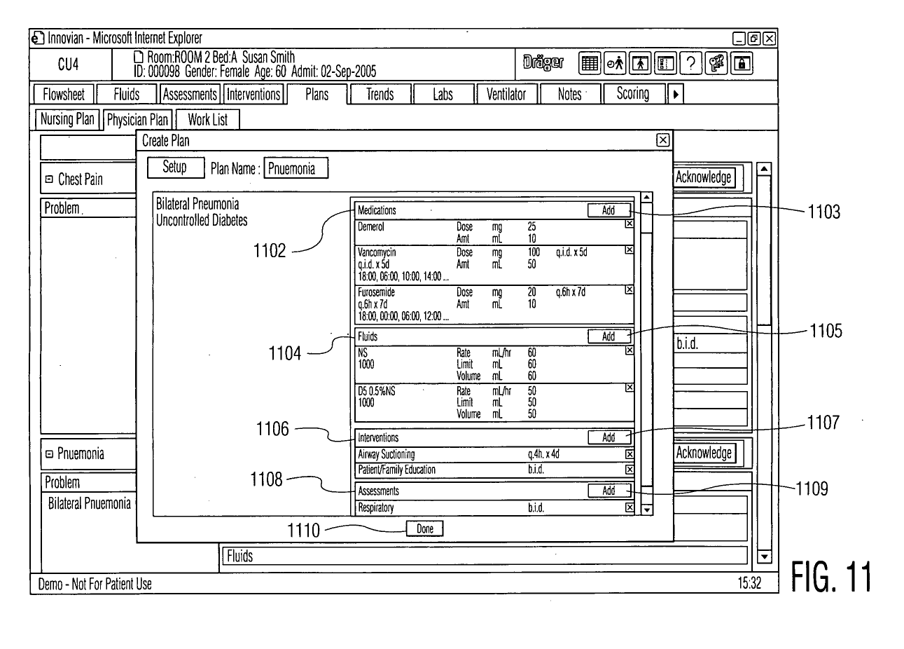

FIG. 11 is a further exemplary display image of a physician care plan creation screen enabling a user to create a care plan to be implemented on a particular patient having particular medical condition(s). Display image includes plan display box 1100 including all events associated with the particular physician care plan. Medication administration events are selectively displayed in box 1102. Fluid administration events are displayed in box 1104. Intervention events are displayed in box 1106 and assessment events are displayed in box 1108. Each event box 1102, 1104, 1106 and 1108 include a respective image element 1103, 1105, 1107 and 1109 enabling a user to further add additional events to the physician care plan. Once completed system 100 provides an image element 1110 indicating that the physician plan is completed.

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention. This disclosure is intended to cover any adaptations or variations of the embodiments discussed herein.

What is claimed is:

1. A patient treatment planning system, comprising:
at least one repository of medical information of a plurality of different patients;
a data processor for acquiring patient data from said at least one repository for presentation in a user interface display and storing patient data acquired via said user interface into said at least one repository; and
a user interface for initiating generation of data representing a composite display image presenting patient data acquired from said at least one repository using said data processor, said composite display image enabling user initiation of execution of a plurality of different executable applications by said data processor including,
a care planning application and
a medication administration scheduling application, and in response to user entry data scheduling a care plan event for a particular patient, said care planning application automatically initiates care plan event conflict checking in response to scheduling said care plan event for said particular patient and said care planning application automatically conveying data identifying said care plan event and associated context data to said medication administration scheduling application for population of a medication administration schedule for display by said user interface.

2. A system according to claim 1, wherein
said user interface automatically conveys data identifying said care plan event and associated context data to said medication administration schedule without user manual data entry and said context data comprises a patient identifier and care plan event identifier.

3. A system according to claim 1 wherein,
said context data comprises a user identifier and care plan event scheduled time and date and a care plan event description element.

4. A system according to claim 1, wherein
said composite display image enables user initiation of execution of a plurality of different executable applications including, an interventions scheduling application and an assessment scheduling application and in response to user entry of said care plan event for said particular patient, said user interface automatically conveys data identifying said care plan event and associated context data to said interventions scheduling application and said assessment scheduling application.

5. A system according to claim 4, wherein
a display image enabling scheduling of an intervention event comprising an activity involving a healthcare worker performing a service for said particular patient is presented in response to user initiation of execution of said interventions scheduling application and in response to user entry of an intervention event for said particular patient, said user interface automatically conveys data identifying said intervention event and associated context data to said care planning application for population of a care plan schedule of said particular patient.

6. A system according to claim 4, wherein
said care planning application automatically initiates intervention conflict checking in response to scheduling said intervention for said particular patient and
said intervention scheduling application automatically initiates a second conflict checking in addition to said intervention conflict checking performed by said care planning application.

7. A system according to claim 6, wherein
an intervention conflict checking comprises at least one of, (a) duplicate intervention checking and (b) intervention schedule checking.

8. A system according to claim 4, wherein
a display image enabling scheduling of an assessment event comprising an activity involving a healthcare worker performing an assessment of an aspect of a medical condition of said particular patient is presented in response to user initiation of execution of said assessment scheduling application and in response to user entry of an assessment event for said particular patient, said user interface automatically conveys data identifying said assessment event and associated context data to said care planning application for population of a care plan schedule of said particular patient.

9. A system according to claim 4, wherein
said care planning application automatically initiates assessment conflict checking in response to scheduling said assessment for said particular patient and
said assessment scheduling application automatically initiates a second assessment conflict checking in addition to said assessment conflict checking performed by said care planning application.

10. A system according to claim 9, wherein
an assessment conflict checking comprises at least one of, (a) duplicate assessment checking and (b) assessment schedule checking.

11. A system according to claim 1, wherein
a display image enabling scheduling of a medication administration event comprising an activity involving a healthcare worker administering a medication to said particular patient is presented in response to user initiation of execution of said medication administration scheduling application and in response to user entry of a medication administration event for said particular patient, said user interface automatically conveys data identifying said medication administration event and associated context data to said care planning application for population of a care plan schedule of said particular patient.

12. A system according to claim 1, wherein
said medication administration scheduling application includes a patient fluid scheduling application.

13. A system according to claim 8, wherein
said patient fluid scheduling application enables scheduling of at least one of, (i) intravenous medications and (ii) patient fluid output handling.

14. A system according to claim 1, wherein
a care plan display image is presented for scheduling care plan events in response to user initiation of execution of said care planning application and said care plan display image enables a user to schedule a care plan event for said particular patient comprising a medication, intervention or assessment.

15. A system according to claim 1, wherein
a care plan display image is presented for scheduling care plan events in response to user initiation of execution of said care planning application and said care plan display image enables a user to schedule a care plan event comprising medication administration for said particular patient and said care planning application automatically initiates said medication conflict checking in response to scheduling said medication administration for said particular patient using said care plan display image.

16. A system according to claim 15, wherein
a medication conflict checking comprises at least one of, (a) duplicate medication checking, (b) medication interaction checking (c) dosage checking and (d) schedule checking.

17. A system according to claim 1, wherein
said medication administration scheduling application initiates performance of a second medication conflict check in addition to said medication conflict checking initiated by said care planning application.

18. A system according to claim 1, wherein
a conflict resolution display image is presented for resolving conflicts identified by said care plan conflict checking process, said conflict resolution display image notifies a user of conflicts between care plan events and enabling a user to schedule a care plan event including associated context data identified as conflicting with another different care plan event and automatically conveying data identifying said duplicate care plan event and associated context data to said medication administration scheduling application for population of a medication administration schedule for display by said user interface.

19. A computer implemented method for preparing a patient treatment plan comprising the activities of:
providing at least one repository of medical information of a plurality of different patients;
acquiring patient data, via a data processor, from said at least one repository for presentation in a user interface display and storing patient data acquired into said at least one repository; and
initiating generation of data representing a composite display image via a user interface, the composite display image presenting patient data acquired from the at least one repository using the data processor; and
initiating of execution of a plurality of different executable applications by the data processor including,
a care planning application and
a medication administration scheduling application, and in response to user entry data scheduling a care plan event for a particular patient, said care planning application automatically initiates medication conflict checking in response to scheduling the medication administration for the particular patient and the care planning application automatically conveying data identifying the care plan event and associated context data to the medication administration scheduling application for population of a medication administration schedule for display by the user interface.

20. A method according to claim 19, wherein
said activity of generating a composite display image enables user initiation of execution of a plurality of different executable applications including, an interventions scheduling application and an assessment scheduling application and in response to user entry of the care plan event for the particular patient, the user interface automatically conveys data identifying the care plan event and associated context data to the interventions scheduling application and the assessment scheduling application.

21. A method according to claim 20, wherein
said activity of initiating a plurality of different executable applications includes initiating generation of a display image enabling scheduling of an intervention event comprising an activity involving a healthcare worker performing a service for the particular patient is presented in response to user initiation of execution of the interventions scheduling application and in response to user entry of an intervention event for the particular patient, the user interface automatically conveys data identifying the intervention event and associated context data to the care planning application for population of a care plan schedule of said particular patient.

22. A method according to claim 21, further comprising the activities of
automatically initiating intervention conflict checking by the care planning application in response to scheduling the intervention for the particular patient and
automatically initiating a second intervention conflict check by the intervention scheduling application in addition to the intervention conflict checking performed by said care planning application.

23. A method according to claim 22, wherein
an intervention conflict checking comprises at least one of, (a) duplicate intervention checking and (b) intervention schedule checking.

24. A method according to claim 20, wherein
said activity of initiating a plurality of different executable applications includes initiating a display image enabling scheduling of an assessment event comprising an activity involving a healthcare worker performing an assessment of an aspect of a medical condition of the particular patient presented in response to user initiation of execution of the assessment scheduling application and in response to user entry of an assessment event for the particular patient, the user interface automatically conveys data identifying the assessment event and associated context data to the care planning application for population of a care plan schedule of the particular patient.

25. A method according to claim 24, further comprising the activities of:
automatically initiating assessment conflict checking by the care planning application in response to scheduling the assessment for the particular patient and
automatically initiating a second assessment conflict checking performed by the assessment scheduling application in addition to the assessment conflict checking performed by said care planning application.

26. A method according to claim 25, wherein
an assessment conflict checking comprises at least one of, (a) duplicate assessment checking and (b) assessment schedule checking.

27. A method according to claim 20, further comprising the activities of:
initiating generation of a conflict resolution display image for resolving conflicts identified by the care plan conflict checking process,
notifying a user of conflicts between care plan events and enabling a user to schedule a care plan event including associated context data identified as conflicting with another different care plan event and
automatically conveying data identifying the duplicate care plan event and associated context data to the medication administration scheduling application for population of a medication administration schedule for display by the user interface.
